(19) United States
(12) Patent Application Publication
(10) Pub. No.: US 2016/0271019 A1
(43) Pub. Date: Sep. 22, 2016

(54) DETECTING DEVICE

(71) Applicant: KANAE CO., LTD., Osaka-shi (JP)

(72) Inventor: Masahito TANAKA, Osaka (JP)

(21) Appl. No.: 14/413,747

(22) PCT Filed: Jun. 26, 2014
(86) PCT No.: PCT/JP2014/067034

§ 371 Date: Jan. 9, 2015

(30) Foreign Application Priority Data
Sep. 20, 2013 (JP) 2013-195673
Nov. 14, 2013 (JP) 2013-235702

(51) Int. Cl. A61J 7/02; A61J 1/03

(52) U.S. Cl. CPC A61J 7/02; A61J 1/035; A61J 2200/30

(57) ABSTRACT

Provided is a cutting device electrically connectable to a conductive wire of a conductive-wire mounted package provided with the conductive wire that allows for electric current to flow to the package with a drug housed therein to detect a change in current flowing state of the conductive wire which is cut along with discharging of the drug from the conductive-wire mounted package. The detecting device includes a holding part configured to hold therein the conductive-wire mounted package and electrically connectable to the conductive wire. The holding part includes a pair of holding pieces that are movable toward and away from each other, and a positioning structure that is provided in at least one of the pair of holding pieces to position the conductive-wire mounted package relative to the holding part.

### CROSS-REFERENCE TO RELATED APPLICATIONS

This application claims priority to Japanese Patent Applications Nos. 2013-195673 and 2013-235702, the disclosures of which are incorporated herein by reference in their entirety.

### FIELD

The present invention relates to a detecting device that is used for checking whether a drug has been discharged from a package with the drug housed therein.

### BACKGROUND

It is required to provide optimal conditions, such as the dose of the drugs taken by the patient, and the dosing time (hereinafter referred also to drug taking conditions) in order to provide expected effects of the drugs prescribed to the patient. Therefore, it is desirable to manage the information on whether the patient has taken the drugs under the optimal dosing conditions (hereinafter referred also to drug taking information).

For managing the drug taking information, a detecting device, which electrically detects that a drug has been taken out of a package with the drug packed therein (a blister pack or the like, for example), is used (see Patent Literature 1). Specifically, the package includes a body that includes a housing part for housing a drug, and an aluminum foil that is attached to the body to close the housing part. The aluminum foil is provided with an electrically-conductive wire. The detecting device is electrically connectable to the conductive wire provided in the aluminum foil of the package. With this, the detecting device is configured to detect the current flowing state of the conductive wire. Specifically, when a drug is taken out of the package, the aluminum foil is torn while the conductive wire is cut, thereby causing a change in current flowing state of the conductive wire, and hence enabling the detection device to detect such a change. The detected information (date and time at which a change in current flowing state of the conductive wire has occurred, for example) is recorded and checked so that the drug taking information can be managed.

According to the detecting device described above, an end portion of the package is inserted into a groove formed in the detecting device to electrically connect the detecting device to the conductive wire of the package within the groove. Since the detecting device is used in a state where it is attached to a package such as a blister pack, the detecting device having a smallest possible size is preferable. Such a detecting device makes it difficult to have the end portion of the package inserted into the groove of the detecting device. Therefore, it is difficult to attach the detecting device to the package provided with the conductive wire. In addition, when the end portion of the package is inserted into the groove of the detecting device, the end portion may contact the detecting device and break, which results in incomplete electrical connection between the conductive wire of the package and the detecting device.

### CITATION LIST

### Patent Literature

Patent Literature 1: JP 1990-257960 A

### SUMMARY

### Technical Problem

An object of the present invention is to provide a detecting device that is capable of being easily attached to a conductive-wire mounted package provided with a conductive wire that allows for electric current to flow to the package with a drug housed therein, and ensuring the electrical connection to the conductive wire.

### Solution to Problem

According to the present invention, there is provided a detecting device electrically connectable to a conductive wire of a conductive-wire mounted package provided with the conductive wire that allows for electric current to flow to the package with a drug housed therein to detect a change in current flowing state of the conductive wire which is cut along with discharging of the drug from the conductive-wire mounted package, the detecting device including:

a holding part configured to hold therein the conductive-wire mounted package and electrically connectable to the conductive wire;

the holding part including a pair of holding pieces that are movable toward and away from each other, and a positioning structure that is provided in at least one of the pair of holding pieces to position the conductive-wire mounted package relative to the holding part, wherein the conductive wire and the holding part are held into an attached state where both are electrically connected to each other by holding in the holding part the conductive-wire mounted package which has been positioned by the positioning structure;

the positioning structure including at least one of a positioning recess and a positioning projection that are recessed and projected from a surface of at least one of the holding pieces that abuts the conductive-wire mounted package;

the positioning recess being configured to be brought into projection and recess fitting with a fitting projection that is formed in the conductive-wire mounted package to be insertable into the positioning recess; and

the positioning projection being configured to be brought into projection and recess fitting with a receiving recess that is formed in the conductive-wire mounted package to be capable of receiving the positioning projection.

According to the above configuration, since the pair of holding pieces are movable toward and away from each other, the distance between the pair of holding pieces are increased by moving the pair of holding pieces away from each other. Whereby, the conductive-wire mounted package can be easily placed between the pair of holding pieces. Thus, attaching the detecting device to the conductive-wire mounted package (electrical connection between the conductive wire and the detecting device) can be easily achieved.

In addition, provision of the positioning structure enables determination of the positional relation of the conductive-wire mounted package relative to the holding part (specifically, the pair of holding pieces). Thus, electrical connection between the conductive wire and the detecting device can be ensured. Further, since the conductive-wire mounted package can be held in the holding part (specifically, sandwiched by the pair of holding pieces), the attached state of the conductive-wire mounted package to the detective device can be securely maintained.

The positioning structure is composed of at least one of a positioning recess and a positioning projection that is formed in at least one of the holding pieces. With this, when the conductive-wire mounted package is held in the detecting device, the conductive-wire mounted package is brought into projection and recess fitting with the positioning recess and/or the positioning projection. Thus, the positional relation between the detecting device and the conductive-wire mounted package can be securely determined, and electrical connection between the conductive-wire mounted package and the detecting device can be easily achieved.

The detecting device is preferably configured so that the conductive-wire mounted package is composed of a sheet shaped label provided with a conductive wire and a package to which the label is bonded, the label includes a connection part that is electrically connected to the holding part, the package includes a detachable area that is formed to cover the connection part and is detachable, and the holding part is is electrically connectable to the connection part of the label, the connection part being exposed through the cutout part formed by detaching the detachable area from the package.

According to the above configuration, in a state before the detecting device is attached to the conductive-wire mounted package, the connection part of the label is covered by the detachable area of the package. Therefore, it is possible to prevent dust or moisture from adhering to the connection part, or the connection part from being broken. That is, the connection part is protectable by the detachable area. On the other hand, the connection part of the label is exposed through the cutout part by detaching the detachable area from the package (that is, by forming the cutout part). Therefore, the electrical connection between the holding part and the connection part can be easily achieved.

### Effect of the Invention

Thus, according to the present invention, it is possible to provide a detecting device that is capable of being easily attached to the conductive-wire mounted package provided with a conductive wire that allows for electric current to flow to the package with a drug housed therein, and ensuring the electrical connection to the conductive wire.

### BRIEF DESCRIPTION OF DRAWINGS

FIG. 1A is a perspective view showing a package with drugs therein, and a label bonded to the package.

FIG. 1B is a cross sectional view showing a state where a drug has been taken out of the conductive-wire mounted package of FIG. 1A, to which a label is bonded.

FIG. 2A is a plan view showing a detecting device of this embodiment.

FIG. 2B is a side view showing the detecting device of this embodiment.

FIG. 3A is a side view of the detecting device of this embodiment, and a cross sectional view of the conductive-wire mounted package which is held in the detecting device.

FIG. 3B is a side view of the detecting device, and a cross sectional view of the conductive-wire mounted package that is held in the detecting device and has a drug discharged therefrom.

FIG. 4A is a side view of a detecting device of another embodiment.

FIG. 4B is a side view of a detecting device of still another embodiment, and a side view of a conductive-wire mounted package to which the detecting device is being attached.

FIG. 5A is a perspective view showing a conductive-wire mounted package having another form, which is attached to the detecting device of FIG. 4B.

FIG. 5B is a cross sectional view of the package of FIG. 5A taking along a line A-A, and a side view of the detecting device.

FIG. 6 is a perspective view showing a package and a label which together constitute a conductive-wire mounted package to be attached to a detecting device of still another embodiment.

FIG. 7A is a side view of the detecting device of FIG. 6, and a cross sectional view of the conductive-wire mounted package in a state where it is being held in the detecting device.

FIG. 7B is side view of the detecting device of FIG. 6, and a cross sectional view of the conductive-wire mounted package in a state where it is held in the detecting device and has a drug discharged therefrom.

FIG. 8 is a perspective view of a package and a label which together constitute a conductive-wire mounted package to be attached to the detecting device of FIG. 7A and 7B.

FIG. 9A is a side view of the detecting device of FIG. 6, and a cross sectional view of a conductive-wire mounted package in a state where it is being held in the detecting device.

FIG. 9B is a side view of the detecting device of FIG. 6, and a cross sectional view of the conductive-wire mounted package in a state where it is held in the detecting device and has a drug discharged therefrom.

FIG. 10 is a perspective view showing a package and a label which together constitute a conductive-wire mounted package to be held in a detecting device of yet another embodiment.

FIG. 11A is a side view showing a state where a conductive-wire mounted package is being held in the detecting device of FIG. 10.

FIG. 11B is a side view showing a state where the conductive-wire mounted package is held by the detecting device and has a drug discharged therefrom.

FIG. 12 is a perspective view showing a package having another form which constitutes a conductive-wire mounted package to be attached to the detecting device according to the present invention.

FIG. 13 is a plan view showing another form of a label which constitutes a conductive-wire mounted package to be attached to the detecting device according to the present invention.

### DESCRIPTION OF EMBODIMENTS

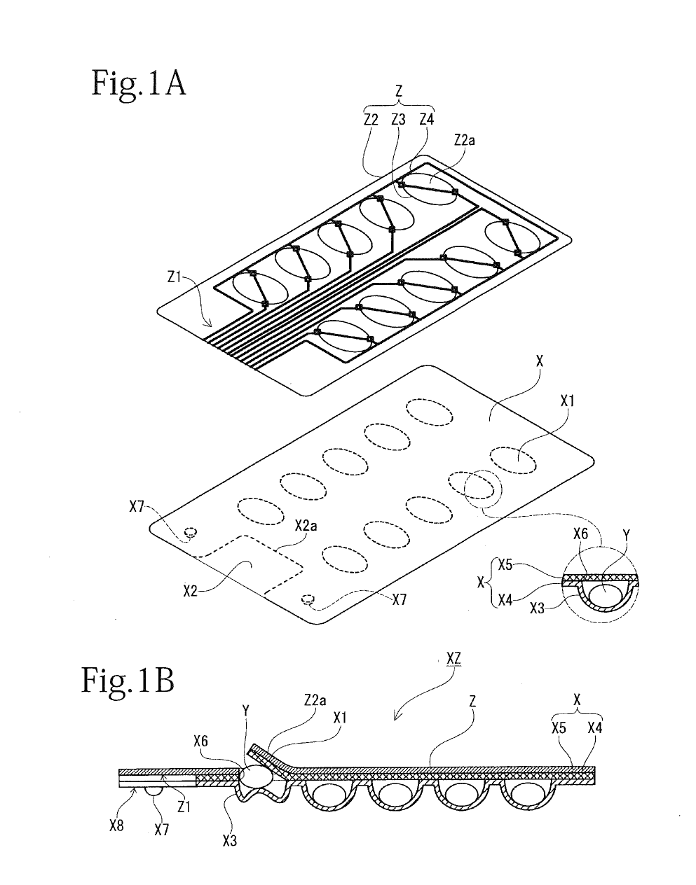

An embodiment of the present invention is hereinafter described with reference to FIG. 1A to FIG. 3B. It is to be noted that identical or corresponding members or parts are given the same reference numerals in the drawings so as to avoid repetitive description thereof.

A detecting device according to the present invention is configured to detect that a drug has been discharged from a package with the drug packed therein. Specifically, the detecting device is electrically connectable to a conductive-wire mounted package provided with a conductive wire that allows for electric current to flow to the package. Whereby, the detecting device is configured to detect a change in current flowing state of the conductive wire. Because of this, the description is made for the conductive-wire mounted package corresponding to the detecting device, prior to the description for the detecting device of the present invention.

In this embodiment, as shown in FIG. 1A, the conductive-wire mounted package is composed of a package X with drugs housed therein, and a label Z bonded to the package X. The package X has a sheet-like shape and is configured to house solid drugs (tablets or capsules) at plural places. The package X also includes discharging areas X1 at plural places, through which the packed drugs are discharged.

The package X also includes a detachable area X2, which is part of an outer peripheral shape of the package X, and is detachable from the package X. The detachable area X2 is composed of an area surrounded by a cutting structure X2a (specifically, perforation or half-cutting) that cuts the package X, specifically of an area surrounded by an edge of the package X and the cutting structure X2a. The detachable area X2 is formed to cover a hereinafter described connection part Z1 of the label Z in a state where the label Z is bonded to the package X. As shown in FIG. 1B, a cutout part X8 is formed in the package X by detaching the detachable area X2 from the package X. Returning to FIG. 1A, the package X is composed of a body X4 that includes housing parts X4 in which drugs Y are housed, and a closing member X5 that closes the housing parts X3.

The body X4 is molded by a sheet shaped member (a sheet of thermoplastic resin or the like, for example) to be recessed at one or more places. In this embodiment, the sheet shaped member is molded to be recessed at plural places to have plural housing parts X of recessed shape, and have plural discharge openings X6, through which the drugs Y are discharged from the housing parts X3. The body X4 includes fitting projections X7 that project toward the side opposite to the surface to which the label Z is bonded. Plural projections X7 are formed with a distance from an end portion of the body X4. In this embodiment, two fitting projections X7 are provided and these two fitting projections are located with the cutout part X8 therebetween.

The closing member X5 is configured to be layered on the sheet shaped body X to close the discharge openings X6 of the body X4. Specifically, the closing member X5 is composed of a sheet shaped material, and layered on or more specifically bonded to the body X4 to cover the discharging openings X6 of the body X4.

The closing member X5 is configured to be torn more easily than the body X4. Specifically, the closing member X5 is composed of a sheet material, such as aluminum foil, and is configured to be torn by pressing, together with the housing part X3, a drug Y housed in the housing part X3 from the outside of the housing part X3 toward the closing member X5, causing the drug to be pressed against the closing member X5 and hence the closing member X5 to be torn. Whereby, the drug Y can be taken out (discharged) from a torn area of the closing member X5.

In other words, the discharging areas X1 are formed by tearable areas of the closing member X5 in the package X. The package X having the above configuration is a so-called blister pack and is known as a package for packing drugs used in the medical field. It is to be noted that, however, the package may contain drugs used in different fields.

The label Z according to this embodiment has a sheet like shape, and can be bonded to a surface in which the discharging areas Xl of the package X are formed. Specifically, the label Z includes an adhesive layer (not shown) on one surface side thereof , and is configured to be bonded through its one surface side to the package X. The label Z is formed to have an outer peripheral shape having a size substantially equal to or slightly smaller than the outer peripheral shape of the package X. With this, the label Z is configured not to project from the package X in a state where the label is bonded to the package X. The label Z includes a connection part Z1 that is electrically connectable to the detecting device of the present invention. The label Z includes a body sheet Z2 formed into a sheet like shape, a tearing structure Z3 that tears the body sheet Z2 along with discharging of the drug Y from the housing part X3, and a conductive wire Z4 that is formed on at least one of the surfaces of the body sheet Z2 so as to be electrically connectable.

The body sheet Z2 includes an insulating layer composed of a sheet material having electrically insulating properties (specifically, an insulating sheet formed of synthetic resin, synthetic paper, paper or the like), and an adhesive layer formed on one surface of the sheet material. Any sheet material is usable for the body sheet Z2 as long as it has electric insulating properties through its entire portion, and may include an insulating layer composed of plural sheet materials (not shown) stacked together.

The tearing structure Z3 is formed along a certain area within the body sheet Z2, and specifically formed to surround a certain area. In this embodiment, when the label Z is bonded to the package X, the tearing structure Z3 is formed to continuously or intermittently surround an area overlapping each discharging area X1 of the package X. The tearing structure Z3 is formed to have an annular shape (an elliptical shape in this embodiment) to correspond to the outer peripheral shape of the discharging area X1. Whereby, an area surrounded by the tearing structure Z3 of the body sheet Z2 (tearing structure inner area) Z2a is formed to overlap (specifically cover) the discharging area X1.

The tearing structure Z3 is not necessarily limited to a certain structure, and is formed, for example, by partially reducing a thickness of the body sheet Z2. Specifically, the tearing structure Z3 is formed by forming a line-shaped reduced thickness part between an inner area surrounded by the tearing structure Z3 and an area outside the inner area. Whereby, the tearing structure Z3 is configured to be torn more easily than the area other than the tearing structure Z3.

The conductive wire Z4 is formed by stacking a material having electric conductivity (silver, aluminum or the like, for example) on one surface of the body sheet Z2. A method for forming the conductive wire Z4 is not necessarily limited to a certain method, and it is possible to employ, for example, a method, in which silver ink is printed or aluminum edge treatment is performed on one surface of the body sheet Z2. The conductive wire Z4 is formed to have respective end portions converging to an end portion of the body sheet Z2 to thereby constitute a conductive circuit. That is, the connection part Z1 of the label Z is formed at a position to which the end portions of the conductive wire Z4 converge.

The conductive wire Z4 is formed to cross the tearing structure Z3, and overlaps the discharging area X1 of the package X when the label Z is bonded to the package X. Whereby, as shown in FIG. 1B, in a state where the conductive-wire mounted package XZ is formed by bonding the label Z to the package X, the drug Y is discharged from the package X so that the body sheet Z2 is torn through the tearing structure Z3 along with discharging, as shown in FIG. 1A. At this time, the conductive wire Z4 is cut at a position crossing the tearing structure Z3. That is, the conductive wire Z4 is configured to be cut along with discharging of the drug Y from the package X.

When the detecting device according to the present invention is attached to the conductive-wire mounted package XZ, the end portion of the package X is cut by way of the cutting structure X2a, and thereby the detachable area X2 is detached from the package X. Whereby, as shown in FIG. 1B, the cutout part X8 is formed in the package X. Upon formation of the cutout part X8, the connection part Z1 of the label Z covered by the detachable area X2 is exposed to the inside the cutout part X8.

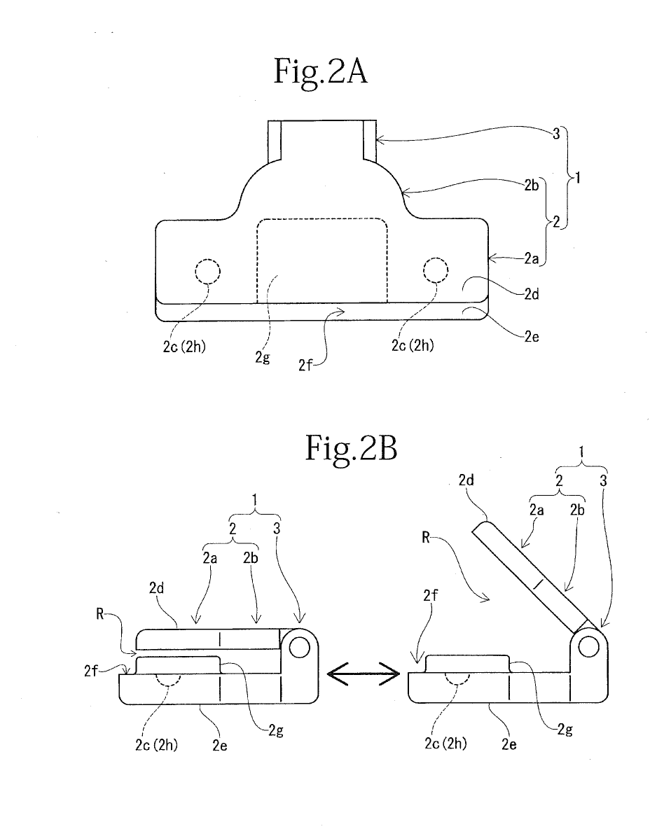

As the detecting device attachable to the conductive-wire mounted package XZ having the above configuration, a detecting device 1 shown in FIG. 2A and FIG. 2B can be cited. As shown in FIG. 2A, the detecting device 1 includes a holding part 2, which is composed of a pair of holding pieces 2d and 2e (hereinafter described), holds therein the conductive-wire mounted package XZ, and a coupling part 3 that couples the pair of holding pieces 2d and 2e.

The holding part 2 includes a first portion 2a that has a shape (rectangular shape) with an elongated side in one direction to contact the conductive-wire mounted package XZ. The holding part 2 includes a second portion 2b that is formed between the first portion 2a and the coupling part 3 to be located between both ends in the longitudinal direction of the first portion 2a (specifically, at a substantially center portion). The holding part 2 further includes a positioning structure 2c that positions the conductive-wire mounted package XZ relative to the detecting device 1.

The holding part 2 is composed of the pair of holding pieces 2d and 2e that are configured to hold or sandwich the conductive-wire mounted package XZ therebetween. That is, the pair of holding pieces 2d and 2e each have a portion constituting the first portion 2a of the holding part 2, and a portion constituting a second portion 2b of the holding part 2. The pair of holding pieces 2d and 2e are arranged to overlap each other, and have end portions coupled with the coupling part 3. In this embodiment, the coupling part 3 has a hinge structure through which the end portions of the pair of holding pieces 2d and 2e are coupled together.

The first holding piece 2e is configured to have part not overlapping the second holding piece 2d. That is, the holding part 2 has a non-overlapping part 2f, through which the pair of holding pieces 2d and 2e do not overlap each other. The non-overlapping part 2f is formed in an end portion of the holding part 2 along the longitudinal direction of the holding part 2 (specifically, along the entire area in the longitudinal direction). The first holding piece 2e includes an abutting part 2g that abuts against the connection part Z1 of the label Z. The abutting part 2g is electrically connectable to the conductive wire Z4 constituting the connection part Z1. That is, the detecting device 1 is electrically connectable to the conductive wire Z4 at the abutting part 2g.

As shown in FIG. 2B, the holding part 2 is configured to hold therein the conductive-wire mounted package XZ by way of the pair of holding pieces 2d and 2e which are movable toward and away from each other. In this embodiment, the pair of holding pieces 2d and 2e are configured to have first end portions (end portions on the side opposite to the coupling part 3, and formed on the side on which the non-overlapping part 2f is formed) that are pivotally movable toward and away from each other about the coupling part 3. In the following description, a state where the first end portions of the pair of holding pieces 2d and 2e are located away from each other is referred as a state where the holding part 2 (specifically the pair of holding pieces 2d and 2e) is held in an opened state. Further, a state where the first end portions of the pair of holding pieces 2d and 2e are located close to each other is referred as a state where the holding part 2 (specifically the pair of holding pieces 2d and 2e) is held in a closed state.

The pair of holding pieces 2d and 2e are configured to hold or sandwich the conductive-wire mounted package XZ therebetween when in the closed state. Specifically, with the conductive-wire mounted package XZ held or sandwiched between the pair of holding pieces 2d and 2e, the conductive-wire mounted package XZ is urged toward the second holding piece 2d by the first holding piece 2e. Along with this, the conductive-wire mounted package XZ is urged toward the first holding piece 2e by the second holding piece 2d. Whereby, the conductive-wire mounted package XZ is held or sandwiched by the pair of holding pieces 2d and 2e. It is to be noted that the method for allowing the pair of holding pieces 2d and 2e to hold or sandwich the conductive-wire mounted package XZ therebetween is not necessarily limited to the above method, and it may be configured so that the conductive-wire mounted package XZ is held or sandwiched by the pair of holding pieces 2d and 2e through frictions between the end portions which together constitute a hinge structure of the pair of holding pieces 2d and 2e, or the conductive-wire mounted package XZ is held by way of action of a spring member provided in the hinge structure.

The holding part 2 is configured to form a space R between the pair of holding pieces 2d and 2e when the pair of holding pieces 2d and 2e are in the closed state. That is, the holding part 2 is configured to hold the conductive-wire mounted package XZ in the space R.

Returning to FIG. 2A, the positioning structure 2c is formed at each of both ends in the longitudinal direction of the holding part 2. The positioning structure 2c is formed in an area through which the pair of holding pieces 2d and 2e overlap each other. As shown in FIG. 2B, the positioning structures 2c are provided in the first holding piece 2e. In this embodiment, the positioning structures 2c each are composed of a positioning recess 2h formed to be recessed from a surface of the first holding piece 2e abutting against the conductive-wire mounted package XZ. The positioning recess 2h is engageable with the conductive-wire mounted package XZ (specifically each of the fitting projections X7) through recess and projection fitting.

The holding part 2 (specifically, at least one of the pair of holding pieces 2d and 2e) includes a detecting device that detects the current flowing state of the conductive wire Z4 of the label Z by being electrically connected to the conductive wire Z4. The detecting device may be a device that records a change in current flowing state of the conductive wire Z4, or transmits such a change to an outside equipment. Such a recording device or a transmission device may be provided in the holding part 2 separately from the detecting device. In this embodiment, the detecting device is provided in the abutting part 2g.

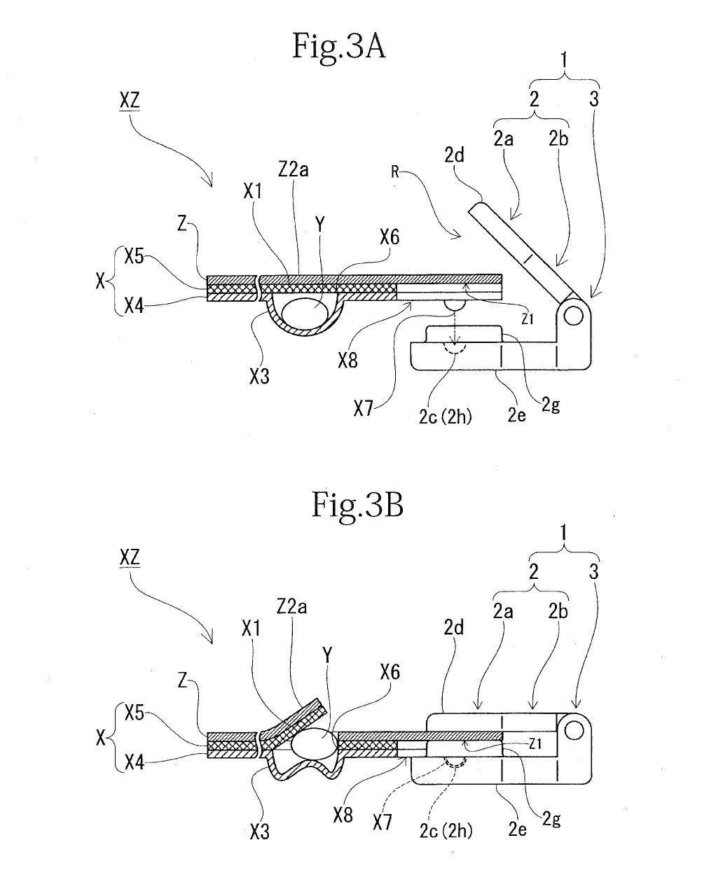

Next, the description is made for the method of using the detecting device 1 having the above configuration. As shown in FIG. 3A, the pair of holding pieces 2d and 2e are first brought into the opened state. Then, the conductive-wire mounted package XZ is placed between the pair of holding pieces 2d and 2e. At this time, the fitting projections X7 of the conductive-wire mounted package XZ are inserted into the positioning recesses 2h of the detecting device 1, so that the fitting projections X7 and the positioning recesses 2h are brought into projection and recess fitting with each other.

Then, as shown in FIG. 3B, the conductive-wire mounted package XZ is held to be sandwiched by the pair of holding pieces 2d and 2e by closing the pair of holding pieces 2d and 2e. At this time, the connection part Z1 of the label Z is covered by the holding part 2, while it is electrically connected to the detecting device 1 (specifically, the abutting part 2g). Whereby, the detecting device 1 is attached to the conductive-wire mounted package XZ.

Then, with the detecting device 1 attached to the conductive-wire mounted package XZ, the drug Y is discharged from the housing part X3 of the package X. Along with discharging of the drug Y, the conductive wire Z4 is cut, which causes a change in current flowing state of the conductive wire Z4. Whereby, such a change is detected by the detecting device 1. In a case where the information such as date and time in which such a current flowing state change occurred (drug taking information) can be recorded by the detecting device 1, or can be transmitted to an outside equipment, whether the drug Y has been discharged or not from the package X (or whether the drug Y has been appropriately taken or not) can be checked by checking the drug taking information.

As described above, according to the detecting device of the present invention, it is possible to achieve ease of attachment to the conductive-wire mounted package provided with a conductive wire that allows for electric current to flow to the package with a drug housed therein, and ensured electric connection with the conductive wire.

That is, since the pair of holding pieces 2d and 2e are movable toward and away from each other, the distance between the pair of holding pieces 2d and 2e can be increased by moving the pair of holding pieces 2d and 2e away from each other. Whereby, the conductive-wire mounted package XZ can be easily placed between the pair of holding pieces 2d and 2e. Thus, the detecting device 1 can be easily attached to the conductive-wire mounted package XZ, or electrical connection between the conductive wire Z4 and the detecting device 1 can be easily achieved.

In addition, provision of the positioning structure 2c enables the conductive-wire mounted package XZ to be positioned or preferably fixed relative to the holding part 2 (specifically, the pair of holding pieces 2d and 2e). Therefore, the electrical connection between the conductive wire Z4 and the detecting device 1 can be ensured. Further, the conductive-wire mounted package XZ can be held in the holding part 2 or sandwiched between the pair of holding pieces 2d and 2e. Therefore, the attached state of the conductive-wire mounted package XZ to the detecting device 1 can be securely maintained.

The positioning recess 2h formed in the first holding piece 2e is brought into projection and recess fitting with the conductive-wire mounted package XZ (fitting projections X7) when the conductive-wire mounted package XZ is held in the detecting device 1. Therefore, the relative positioning between the detecting device 1 and the conductive-wire mounted package XZ can be securely determined (preferably fixed), so that the electrical connection between the conductive wire Z4 and the detecting device 1 can be more ensured.

Further, in a state before the detecting device 1 is attached to the conductive-wire mounted package XZ, the connection part Z1 of the label Z is covered by the detachable area X2 of the package. Therefore, it is possible to prevent dust or moisture from adhering to the connection part Z1, or the connection part Z1 from being broken. That is, the connection part Z1 can be protected by the detachable area X2. On the other hand, the connection part Z1 of the label Z is exposed to the outside through the cutout part X8 by detaching the detachable area X2 from the package X, that is, by forming the cutout part X8. Therefore, the electrical connection between the holding part 2 and the connection part Z1 can be easily achieved.

The detecting device of the present invention is not necessarily limited to the above embodiments, and may be subjected to various modifications within the gist of the present invention. Also, the configurations or methods of the above-described embodiments may be optionally employed and combined together (a configuration or method of one embodiment may be optionally combined with a configuration or method of another embodiment. Further, it is a matter of course that a configuration or method according to each of various modified examples mentioned below may be optionally selected, and employed in a configuration or method of the above-described embodiments.

For example, in the above-described embodiments, the pair of holding pieces 2d and 2e are coupled together by way of the hinge structure, and the conductive-wire mounted package XZ can be held or sandwiched by the pair of holding pieces 2d and 2e through friction of the hinge mechanism or the action of the spring member within the hinge mechanism. However, the present invention is not necessarily limited to this.

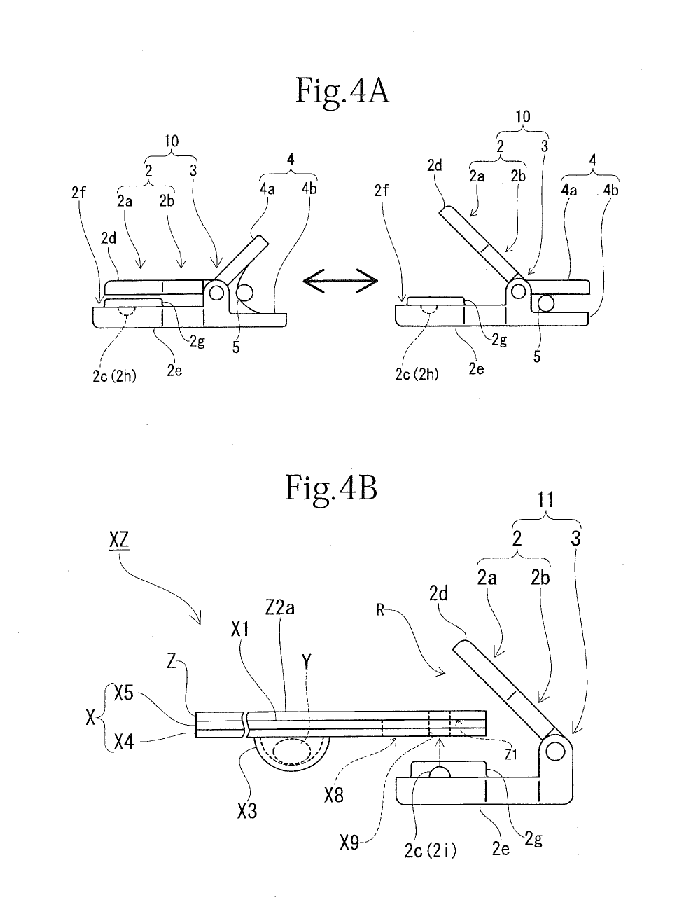

For example, a detecting device 10 shown in FIG. 4A includes a finger grip 4 that is formed to extend from the coupling part 3 to enable the user to hold it by fingers, and a spring member 5 attached to the finger grip 4. The finger grip 4 is composed of a pair of gripping pieces 4a and 4b. One grip piece 4b is connected to an end portion constituting the coupling part 3 of the first holding piece 2e, and another grip piece 4a is connected to an end portion constituting the coupling part 3 of the second holding piece 2d. Whereby, the gripping pieces 4a and 4b are pivotally moved toward and away from each other about the coupling part 3, so that the pair of holding pieces 2d and 2e are opened and closed.

The spring member 5 is located between the pair of gripping pieces 4a and 4b, and the pair of gripping pieces 4a and 4b are urged in a direction in which they are pivotally moved away from each other about the coupling part 3 by the action of the spring member 5. Therefore, the pair of holding pieces 2d and 2e are held in the opened state by applying a force to move the pair of gripping pieces 4a and 4b toward each other against the urging force of the spring member 5. Whereby, the conductive-wire mounted package XZ can be easily placed between the pair of holding pieces 2d and 2e. In other words, the conductive-wire mounted package XZ can be securely held or sandwiched by the pair of holding pieces 2d and 2e, since they are held in the closed state by the action of the spring member 5.

In the above embodiments, the positioning structure 2c is composed of the positioning recess 2h. However, the present invention is not necessarily limited to this. For example, as shown in FIG. 4B, the positioning structure 2c may be composed of a positioning projection 2i formed by forming the surface of the first holding piece 2e to be projected, which surface abuts against the conductive-wire mounted package XZ. In this configuration, instead of the fitting projection X7, a receiving recess X9 (specifically, a through-hole passing through the package X) for receiving the positioning projection 2i is formed in the conductive-wire mounted package XZ. Thus, the conductive-wire mounted package XZ and the detecting device 11 are positioned relative to each other by projection-recess fitting between the positioning projection 2i and the receiving recess X9.

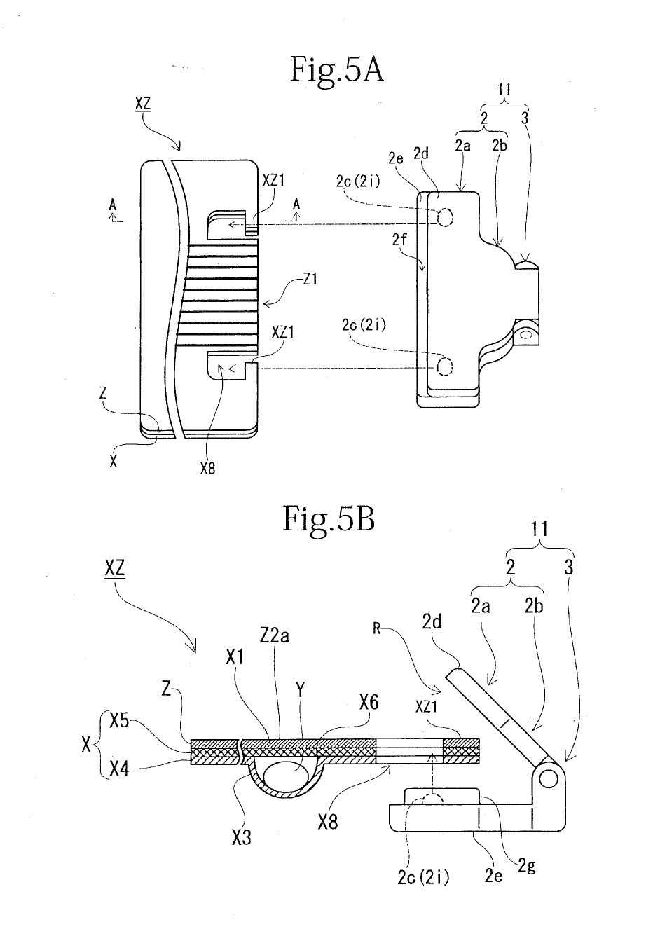

As described above, in the case where the detecting device includes the positioning projection 2i, as shown in FIG. 5A and FIG. 5B, the positioning projection 2i may be inserted into the cutout part X8 formed in the conductive-wire mounted package XZ (specifically, the package X). Whereby, the positioning is achieved by the engagement between the conductive-wire mounted package XZ and the positioning projection 2i. Specifically, an extension XZ1 is provided to project toward the inside of the cutout part X8 of the conductive-wire mounted package XZ (such extension is formed in an end portion of the conductive-wire mounted package XZ by, for example, cutting off an end portion of the package X or the label Z), so that the positioning projection 2i located inside the cutout part X8 is engaged with the extension XZ1.

In the above embodiments, as the package X, a sheet-shaped member such as a blister pack is used. However, the present invention is not necessarily limited to this. For example, a box shaped member may be used as long as it can be held or sandwiched by the pair of holding pieces 2d and 2e.

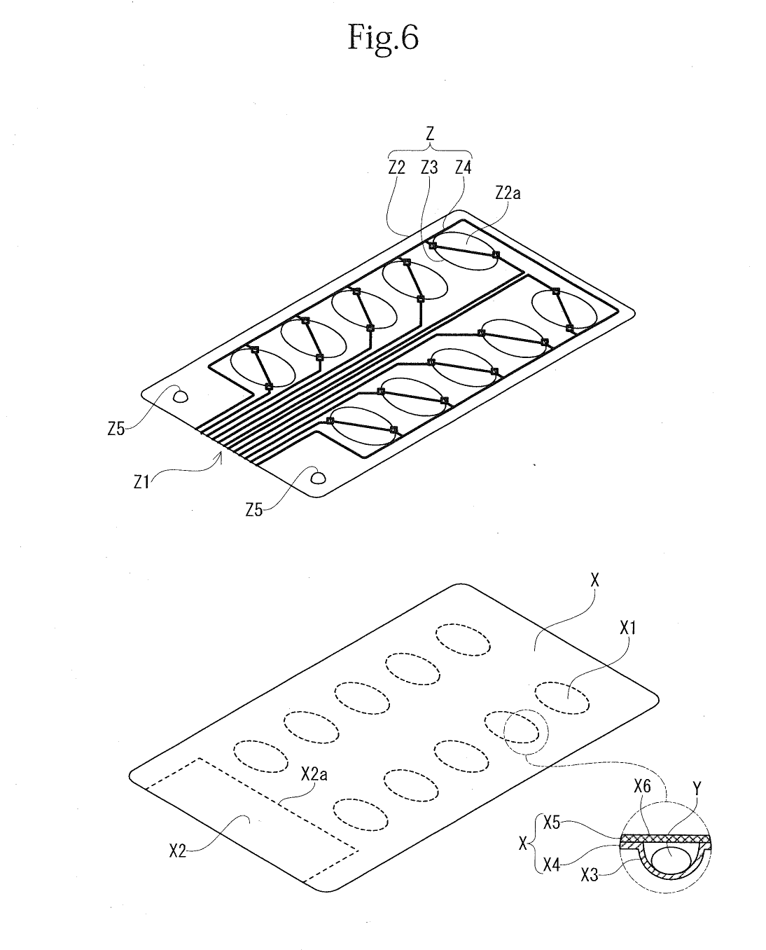

In the above embodiments, the fitting projections X7, and the receiving recesses X9 are formed in the package X. However, the present invention is not necessarily limited to this. For example, these may be formed in the label Z. Specifically, as shown in FIG. 6, a fitting projection Z5 is formed on a surface of the label Z opposite to the surface of the label Z to which the package X is bonded (that is, the surface on the side through which the conductive wire is exposed). Plural fitting projections Z5 are formed on an end portion of the label Z at intervals. In this embodiment, two fitting projections Z5 are formed, and the connection part Z1 is positioned between the two fitting projections Z5.

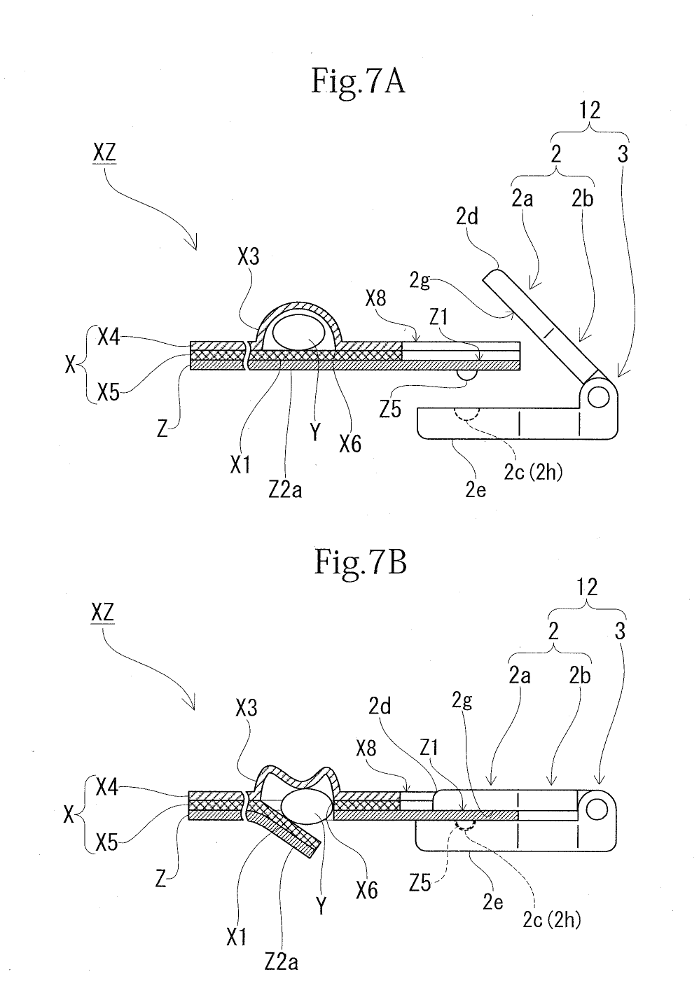

A detecting device 12, which is to be attached to the conductive-wire mounted package XZ including the label Z provided with the fitting projection Z5 and the package X bonded thereto, includes a positioning structure 2c (specifically, the positioning recess 2h) in the first holding piece 2e, as shown in FIG. 7A. The detecting device 12 includes the abutting part 2g that abuts against (specifically, is electrically connected to) the connection part Z1 of the label Z in the second holding piece 2d. When the detecting device 12 is attached to the conductive-wire mounted package XZ, the detachable area X2 is detached from the package X to form the cutout part X8. Thus, the connection part Z1 of the label Z is exposed to the inside of the cutout part X8.

According to the above configuration, as shown in FIG. 7B, subsequent to the projection and recess fitting by fitting the fitting projections Z5 formed in the label Z into the positioning recesses 2h formed in the first holding piece 2e (more specifically, subsequent to the projection and recess fitting by fitting the fitting projections Z5 into the positioning recesses 2h at positions in proximity to the connection part Z1), the pair of holding pieces 2d and 2e are brought into the closed state. Whereby, the electrical connection between the detecting device 12 and the conductive-wire mounted package XZ can be ensured. Specifically, provision of the fitting projections Z5 in the label Z (especially, locating the connection part Z1 between the two fitting projections Z5) enables the label Z with the conductive wire Z4 mounted therein to be positioned or preferably fixed relative to the detecting device 12. Therefore, the positional relation between the detecting device 12 and the connection part Z1 can be securely determined (preferably fixed). Whereby, when the pair of holding pieces 2d and 2e have been brought into the closed state, the abutting part 2g of the detecting device 12 securely abuts against the connection part Z1 of the label Z. Therefore, the electrical connection between the detecting device 12 and the conductive-wire mounted package XZ can be more ensured.

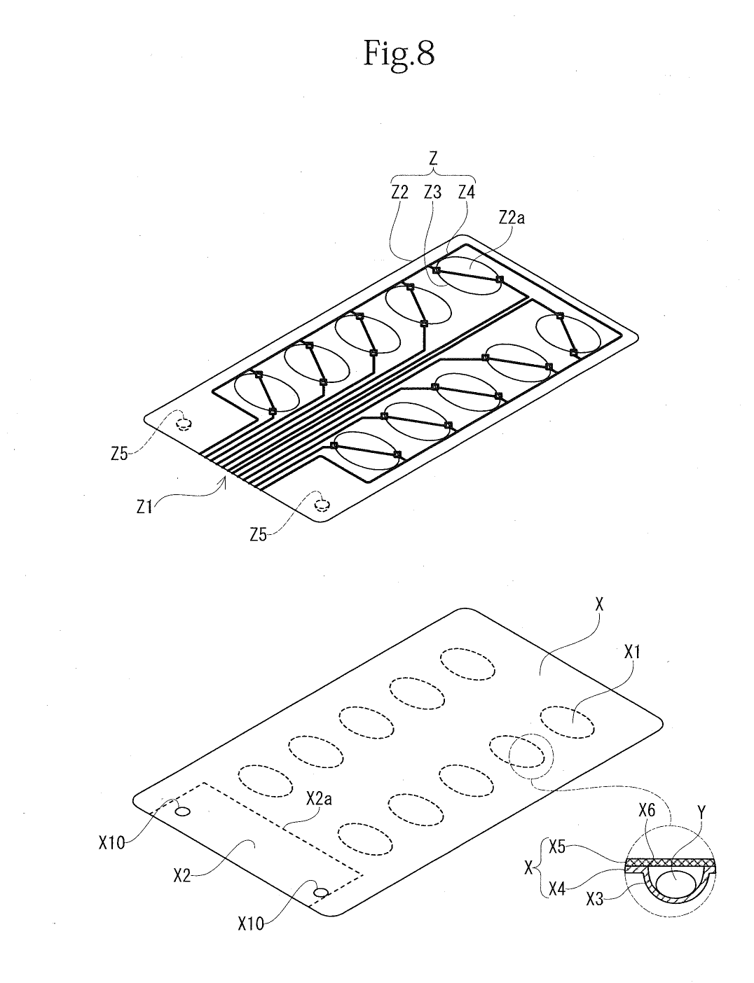

As shown in FIG. 8, the label Z may have the fitting projections Z5 formed on the surface to which the package X is bonded. In this configuration, when the conductive-wire mounted package XZ is formed, fitting-projection receiving portions X10 for receiving the fitting projections Z5 are formed at positions overlapping the fitting projections Z5. The fitting-projection receiving portions X10 are formed in the detachable area X2, and are formed to pass through this area. Then, the detachable area X2 is detached from the package X to form the cutout part X8, thereby allowing the fitting projection Z5 to be exposed to the inside of the cutout part X8.

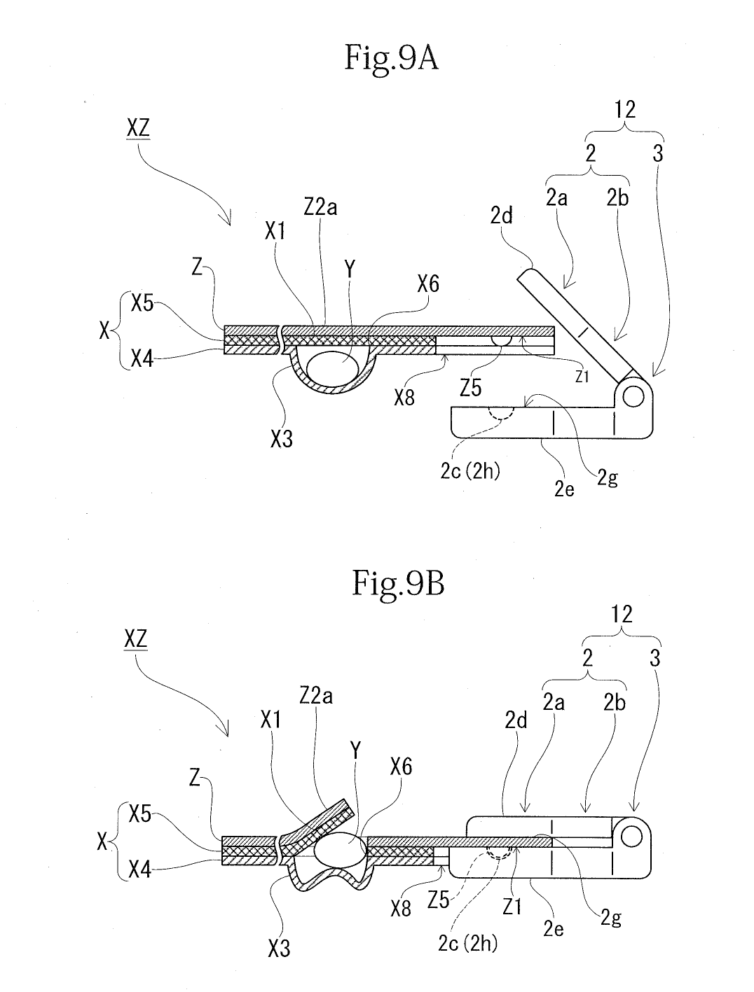

The above-described detecting device 12 is attached to the thus configured conductive-wire mounted package XZ. Then, as shown in FIG. 9B, subsequent to the projection and recess fitting by fitting the fitting projections Z5 formed in the label Z into the positioning recesses 2h formed in the first holding piece 2e (more specifically, subsequent to the projection and recess fitting by fitting the fitting projections Z5 into the positioning recesses 2h at positions in proximity to the connection part Z1), the pair of holding pieces 2d and 2e are brought into the closed state. Whereby, the electrical connection between the detecting device 12 and the conductive-wire mounted package XZ can be more ensured.

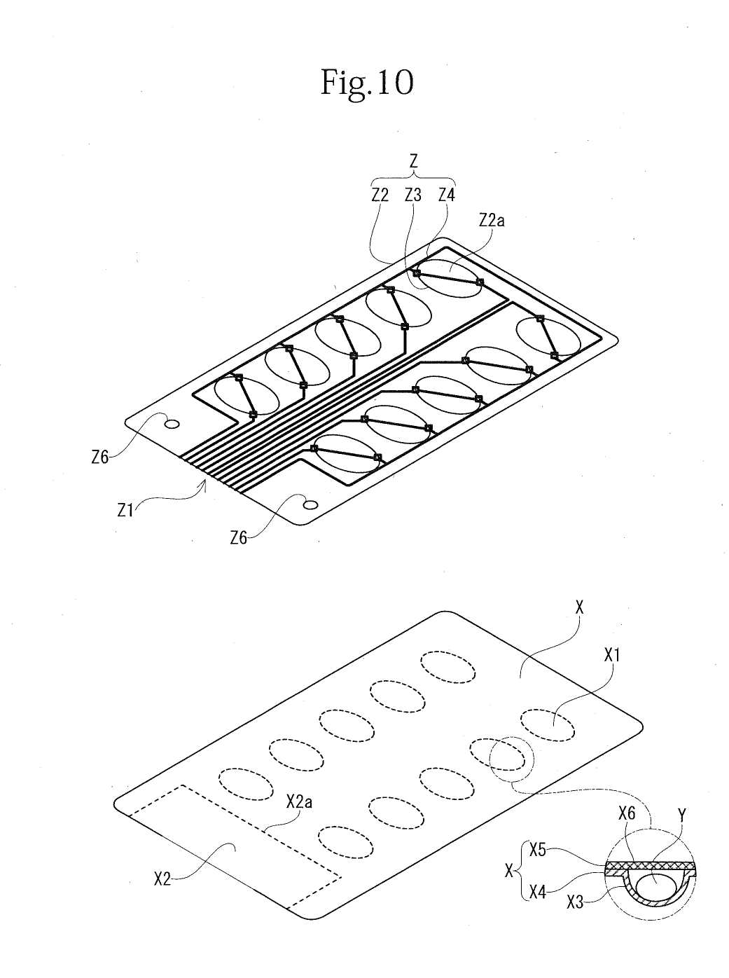

Alternatively, as shown in FIG. 10, receiving recesses (specifically, through-holes passing through the label Z) Z6 may be formed in the label Z. Plural receiving recesses. Z6 are formed in an end portion of the label Z at intervals. In this embodiment, two receiving recesses Z6 are formed, and the connection part Z1 of the label Z is positioned between the two receiving recesses Z6.

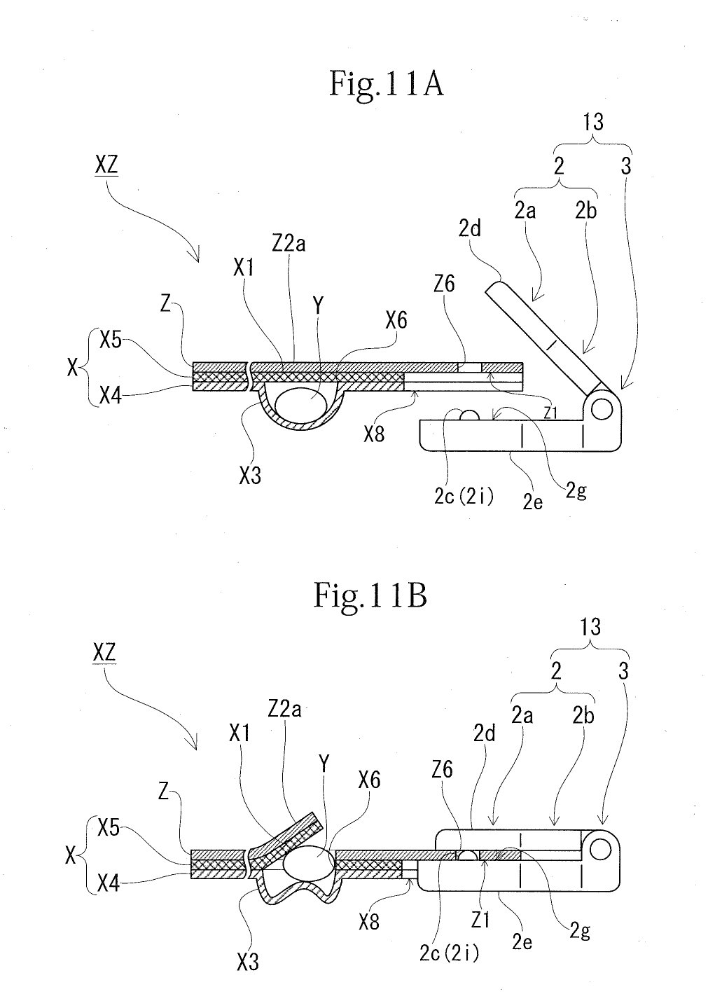

A detecting device 13, which is to be attached to the conductive-wire mounted package XZ including the label Z provided with the receiving recesses Z6 and the package Z bonded thereto, preferably includes the positioning structure 2c (specifically, the positioning projection 2i), and the abutting part 2g that abuts against the connection part Z1 of the label Z (specifically, is electrically connected to) the connection part Z1 of the label Z in the first holding piece 2e, as shown in FIG. 11A.

According to the above configuration, as shown in FIG. 11B, subsequent to the projection and recess fitting by fitting the positioning projections 2i into the receiving recesses Z6 formed in the label Z (more specifically, subsequent to the projection and recess fitting by fitting the positioning projections 2i into the receiving recesses Z6 in proximity to the connection part Z1), the pair of holding pieces 2d and 2e are brought into the closed state. Whereby, the electrical connection between the detecting device 13 and the conductive-wire mounted package XZ can be ensured. Specifically, provision of the receiving recesses Z6 in the label Z (especially, locating the connection part Z1 between the two receiving recesses Z6) enables the label Z with the conductive wire Z4 mounted therein to be positioned or preferably fixed relative to the detecting device 13. Therefore, the he relative positioning between the detecting device 13 and the connection part Z1 can be securely defined (preferably fixed). Whereby, when the pair of holding pieces 2d and 2e have been brought into the closed state, the abutting part 2g of the detecting device securely abuts against the connection part Z1 of the label Z. Therefore, the electrical connection between the detecting device 13 and the conductive-wire mounted package XZ can be ensured.

In the above embodiments, the holding part 2 has the non-overlapping part 2f formed therein. However, the present invention is not necessarily limited to this. For example, the non-overlapping part 2f may not be formed by providing the pair of holding pieces 2d and 2e with substantially the same shape.

In the above embodiments, the positioning structure 2c is provided in the first holding piece 2e. However, the present invention is not necessarily limited to this. For example, the positioning structure 2c may be provided in the second holding piece 2d.

In the above embodiments, the positioning structure 2c is composed of the positioning recess 2h or the positioning projection 2i. However, the present invention is not necessarily limited to this. For example, the positioning structure 2c may be composed of the positioning recess 2h and the positioning projection 2i.

In the above embodiments, the conductive-wire mounted package XZ is formed by bonding the label Z to the package X. However, the present invention is not necessarily limited to this. For example, the conductive-wire mounted package XZ may be formed by forming a conductive fire by printing on the closing member X5 of the package X.

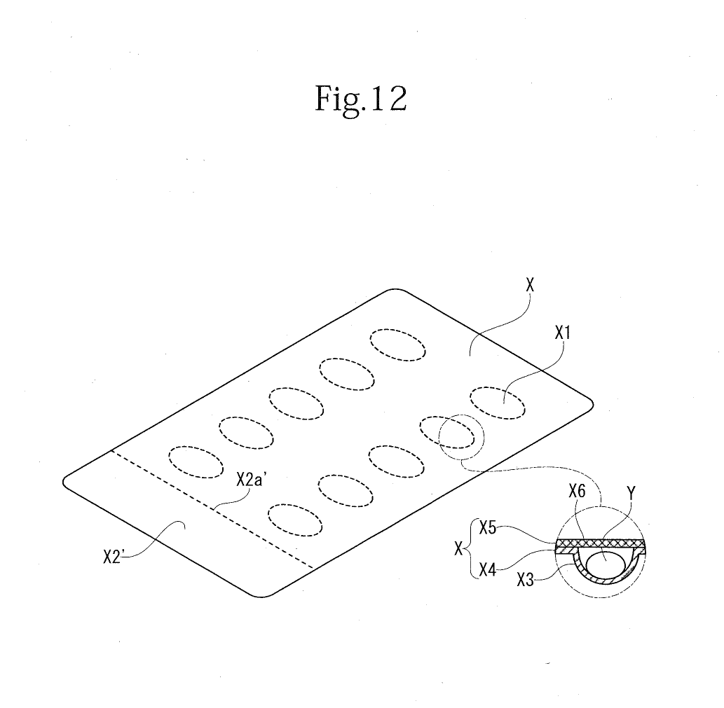

In the above embodiments, the cutout part X8 is formed by detaching the detachable area X2 from the package X. However, the present invention is not necessarily limited to this. For example, as shown in FIG. 12, the package X may be provided with a cutting structure X2a′ formed to be straight with opposite end portions overlapping end portions of the package X. In this configuration, a detachable area X2′ is composed of the entire area of an end portion extending from the cutting structure X2a′ as a boundary, on which none of the housing parts X3 of the package X is formed (that is, an end portion including an area covering the connection part Z1 of the label Z). The cutout part X8 is not formed in the package X by thus detaching the detachable area X2′.

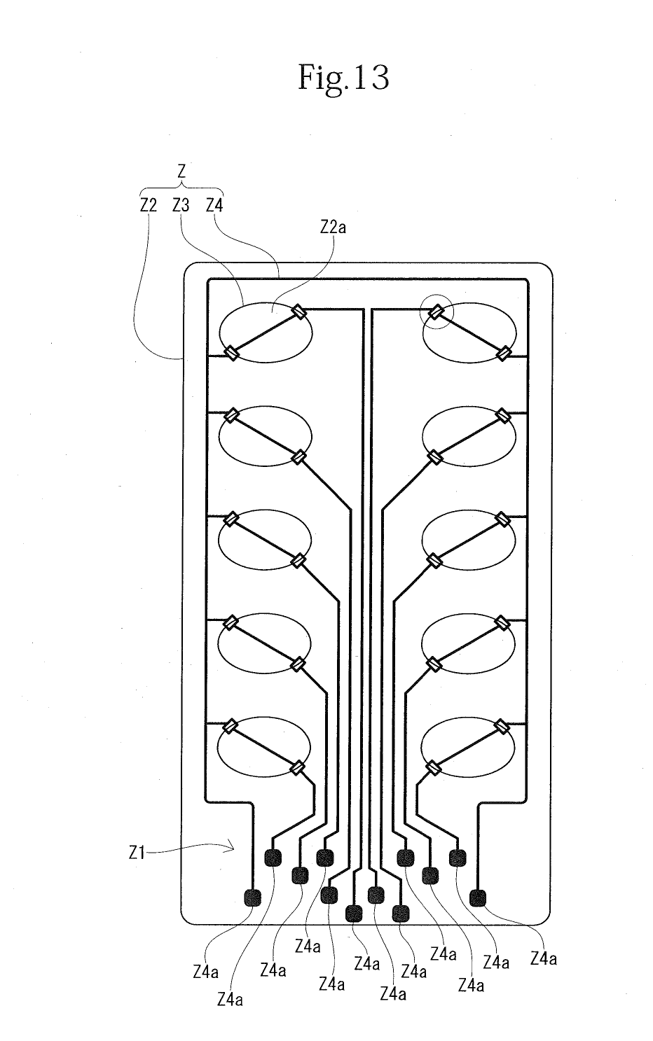

As shown in FIG. 13, the connection part Z1 of the label Z is preferably provided with plural detecting-device connection parts Z4a that are electrically connected to the detecting device of each of the above embodiments. The detecting-device connection parts Z4a are formed at end portions of the conductive wire Z4, and are configured not to be aligned in straight line along one direction (more specifically, along an extending direction of the end portion of the label Z, the end portion being attached to the detecting device of each of the above embodiments).

According to the above configuration, the detecting-device connection parts Z4a are located at positions separating away from each other. Thus, it is possible to prevent occurrence of failure of the electrical connection between the detecting device of each of the above embodiments and the label Z. Specifically, the abutting part 2g of the detecting device of each of the above embodiments is provided with plural areas (not shown)(hereinafter referred also to abutting areas) that are provided at positions corresponding to the respective detecting-device connection parts Z4a to abut against (being electrically connected to) the respective detecting-device connection parts Z4a. Therefore, when the detecting-device connection parts Z4a are aligned in straight line along one direction and hence have narrow intervals between the adjacent detecting-device connection parts Z4a, even slight shifting of the positional relation between the label Z and the detecting device at the time of attaching the conductive-wire mounted package XZ to the detecting device may cause one abutting area to abut against the adjacent detecting-device connection parts Z4a and hence cause occurrence of fault of the electrical connection. However, with the detecting-device connection parts Z4a being not aligned in straight line (specifically, not overlapping each other on a straight line), the distance between the adjacent detecting-device connection parts Z4a is increased. Whereby, it is possible to prevent one abutting area from abutting against plural detecting-device connection parts Z4a, and hence prevent occurrence of failure of the electrical connection as described above.

### REFERENCE SIGNS LIST

1, 10, 11, 12, 13: Detecting Device
2: Holding Part
2a: First Portion
2b: Second Portion
2c: Positioning Structure
2d, 2e: Holding Piece
2f: Non-overlapping Part
2g: Abutting Part
2h: Positioning Recess
2i: Positioning Projection
3: Coupling Part
4: Finger Grip
4a, 4b: Gripping Piece
5: Spring Member
X: Package
X1: Discharging Area
X2, X2′: Detachable Area
X2a, X2a′: Cutting Structure
X3: Housing Part
X4: Body
X5: Closing Member
X6: Discharge Opening
X7, Z5: Fitting Projection
X8: Cutout Part
X9, Z6: Receiving Recess

X10: Fitting-projection Receiving Portion
Z: Label
Z1: Connection Part
Z2: Body Sheet
Z3: Tearing Structure
Z4: Conductive Wire
Z4a: Detecting-device Connection Part
XZ: Conductive-wire Mounted Package

1. A detecting device electrically connectable to a conductive wire of a conductive-wire mounted package provided with the conductive wire that allows for electric current to flow to the package with a drug housed therein to detect a change in current flowing state of the conductive wire which is cut along with discharging of the drug from the conductive-wire mounted package, the detecting device comprising:
a holding part configured to hold therein the conductive-wire mounted package and electrically connectable to the conductive wire;
the holding part comprising a pair of holding pieces that are movable toward and away from each other, and a positioning structure that is provided in at least one of the pair of holding pieces to position the conductive-wire mounted package relative to the holding part, wherein the conductive wire and the holding part are held into an attached state where both are electrically connected to each other by holding in the holding part the conductive-wire mounted package which has been positioned by the positioning structure;
the positioning structure comprising at least one of a positioning recess and a positioning projection that are recessed and projected from a surface of at least one of the holding pieces that abuts the conductive-wire mounted package;
the positioning recess being configured to be brought into projection and recess fitting with a fitting projection that is formed in the conductive-wire mounted package to be insertable into the positioning recess; and
the positioning projection being configured to be brought into projection and recess fitting with a receiving recess that is formed in the conductive-wire mounted package to be capable of receiving the positioning projection.

2. The detecting device according to claim 1, wherein:
the conductive-wire mounted package comprises a sheet shaped label provided with a conductive wire and a package to which the label is bonded;
the label includes a connection part that is electrically connected to the holding part;
the package includes a detachable area that is formed to cover the connection part and is detachable; and
the holding part is electrically connectable to the connection part of the label, the connection part being exposed through the cutout part formed by detaching the detachable area from the package.
